(19) United States
(12) Patent Application Publication
(10) Pub. No.: US 2020/0147590 A1
(43) Pub. Date: May 14, 2020

(54) OXYGEN REDUCTION CATALYST, MEMBRANE ELECTRODE ASSEMBLY, AND FUEL CELL

(71) Applicant: SHOWA DENKO K.K., Tokyo (JP)

(72) Inventors: Takuya IMAI, Tokyo (JP); Kazuo FURUYA, Tokyo (JP); Kunchan LEE, Tokyo (JP); Suguru SAKAGUCHI, Tokyo (JP); Yoshishige OKUNO, Tokyo (JP)

(73) Assignee: SHOWA DENKO K.K., Tokyo (JP)

(21) Appl. No.: 16/473,422

(22) PCT Filed: Dec. 27, 2017
(86) PCT No.: PCT/JP2017/046946

§ 371 Date: Jun. 25, 2019

(30) Foreign Application Priority Data
Dec. 27, 2016 (JP) 2016-253406

(51) Int. Cl. B01J 23/75; H01M 4/90; H01M 8/10

(52) U.S. Cl. CPC B01J 23/75; H01M 8/10; H01M 4/90

(57) ABSTRACT

An oxygen reduction catalyst containing as constituent elements cobalt, sulfur, and a transition metal element M being at least one element selected from chromium and molybdenum, the oxygen reduction catalyst being ascertained to have a crystal structure of a cobalt disulfide cubic crystal in powder X-ray diffraction measurement, and having a molar ratio of the transition metal element M to cobalt (M/cobalt) of 5/95 to 15/85. Also disclosed is an electrode having a catalyst layer containing the oxygen reduction catalyst, a membrane electrode assembly including a polymer electrolyte membrane wherein the electrode serves as a cathode and/or an anode, and a fuel cell including the membrane electrode assembly.

### TECHNICAL FIELD

The present invention relates to an oxygen reduction catalyst, a membrane electrode assembly, and a fuel cell, and in detail, the present invention relates to an oxygen reduction catalyst to be a substitute for platinum, the oxygen reduction catalyst containing cobalt disulfide, and a membrane electrode assembly and a fuel cell each using the oxygen reduction catalyst.

### BACKGROUND ART

A polymer electrolyte fuel cell (PEFC) is a fuel cell of a type of interposing a solid polymer electrolyte between an anode and a cathode, supplying fuel to the anode and oxygen or air to the cathode, and reducing oxygen at the cathode, thereby taking out electricity. As the fuel, hydrogen, or methanol or the like is mainly used. In the past, a layer containing a catalyst has been provided on the surface of a cathode and the surface of an anode of a fuel cell in order to enhance the reaction rate of a PEFC and enhance the energy conversion efficiency of a PEFC. As this catalyst, a noble metal is generally used, and platinum, which is highly active among the noble metals, is used mainly.

Attempts to reduce the costs of a catalyst, among others, attempts to obtain a low-cost oxygen reduction catalyst by making an oxygen reduction catalyst which is used for a cathode non-platinum have been made for the purpose of expanding the use of a PEFC.

On the other hand, the cathode of a PEFC is placed in an oxidizing and strongly acidic atmosphere and has high electric potential during operation, and therefore a catalyst material that is stable in a PEFC operating environment is extremely limited. It is known that in such an environment, even when platinum, which is particularly stable among the noble metals, is used as a catalyst, a cathode catalyst is deactivated by oxidation or undergoes dissolution and falling-off due to long-term usage, resulting in deterioration of the activity. From this fact, a large amount of a noble metal needs to be used in a cathode catalyst also from the viewpoint of keeping the power generation performance of a PEFC, which is a major problem in terms of costs and resources.

From those described above, a non-platinum-based oxygen reduction catalyst having high catalytic activity and having in a PEFC operating environment high durability has been desired.

A metal sulfide has a small band gap and exhibits electric conductivity comparable to a metal, and therefore is used as a photo catalyst or as an electrode catalyst for oxidation-reduction reaction. It is known that cobalt sulfide among the metal sulfides can be used as an electrode catalyst for a fuel cell by utilizing the oxygen reduction catalyst performance of a metal sulfide catalyst. However, on the other hand, the durability of cobalt sulfide has been regarded as a problem.

In Patent Literature 1, a layered metal sulfide containing a catalytically active metal intercalated into transition metal disulfide layers is prepared by vacuum-firing two group 4 to 8 transition metals and sulfur, and a platinum-free fuel cell catalyst having a small specific resistance at a particular composition is reported.

Patent Literature 2 reports that a catalyst having higher durability can be produced by adding molybdenum to ruthenium sulfide and thereby making it harder for sulfur to detach than in the case of ruthenium sulfide alone.

Non Patent Literature 1 reports on oxygen reduction behavior of a catalyst containing a transition metal element doped into a thiospinel compound Co₃S₄.

It is known that layered compounds including NbS₂ described in Patent Literature 1 have low oxidation stability, and therefore the layered compounds are not preferable as a fuel cell catalyst in which durability is required. In addition, in Patent Literature 1, a catalyst is prepared by a solid phase method, so that a resultant catalyst has a small specific surface area and therefore is not preferable as a fuel cell catalyst in which high output is required.

In Patent Literature 2, Ru, which is a noble metal, is used in the catalyst and is not preferable in terms of costs.

The oxygen reduction ability of Co₃S₄ described in Non Patent Literature 1 is lower than that of CoS₂ in the first place. Further, it is described that the oxygen reduction ability of a catalyst containing Cr and Mo, each being a transition metal element, doped therein is rather lowered. Moreover, in Non Patent Literature 1, a catalyst containing a transition element doped into CoS₂ is neither described nor suggested.

### CITATION LIST

### Patent Literature

Patent Literature 1: Japanese Patent Laid-Open No. 2005-317288
Patent Literature 2: Japanese Patent Laid-Open No. 2009-43618

### Non Patent Literature

Non Patent Literature 1: Electrochimica Acta 1975, 20, 111-117

### SUMMARY OF INVENTION

### Technical Problem

Under the circumstances of the conventional techniques as described above, an object of the present invention is to provide an oxygen reduction catalyst which has high catalytic activity and high durability and can be a substitute for platinum.

### Solution to Problem

The present inventors have conducted diligent studies in order to solve the problems of the conventional techniques to find that a catalyst containing as constituent elements cobalt, sulfur, and a transition metal element M being at least one element selected from the group consisting of chromium and molybdenum, the catalyst having a particular crystal structure and having a molar ratio of the transition metal element M to cobalt in a particular range is highly active and has high durability, and can be a substitute for platinum, and thereby completed the present invention.

The present invention relates to, for example, the following [1] to [5].

[1]

An oxygen reduction catalyst comprising as constituent elements: cobalt; sulfur; and a transition metal element M being at least one element selected from the group consisting of chromium and molybdenum, the oxygen reduction catalyst being ascertained to have a crystal structure of a cobalt disulfide cubic crystal in powder X-ray diffraction measurement and having a molar ratio of the transition metal element M to cobalt (M/cobalt) of 5/95 to 15/85.

[2]

The oxygen reduction catalyst according to [1], having a cobalt disulfide cubic crystal content of 80% or more.

[3]

An electrode having a catalyst layer containing the oxygen reduction catalyst according to [1] or [2].

[4]

A membrane electrode assembly including a polymer electrolyte membrane disposed between a cathode and an anode, wherein the electrode according to claim [3] is used as the cathode and/or the anode.

[5]

A fuel cell including the membrane electrode assembly according to [4].

### Advantageous Effects of Invention

An oxygen reduction catalyst of the present invention is an oxygen reduction catalyst which is highly active, has high durability, and can be a substitute for platinum. Specifically, the oxygen reduction catalyst of the present invention has high electrode potential, has high durability in a PEFC operating environment, and can realize suppression of a Co dissolution rate in an acidic atmosphere and a high retention rate of oxidation-reduction potential before and after an acid immersion test.

### BRIEF DESCRIPTION OF DRAWINGS

FIG. 1 shows an X-ray diffraction spectrum of an oxygen reduction catalyst (1). Black circle marks ● show peaks of cubic CoS₂.

FIG. 2 shows an X-ray diffraction spectrum of an oxygen reduction catalyst (11). Black circle marks ● show peaks of cubic CoS₂, and a triangle mark Δ shows a peak of monoclinic CrS₂.

FIG. 3 shows an X-ray diffraction spectrum of an oxygen reduction catalyst (12). Black circle marks ● show peaks of cubic CoS₂, and a square mark □ shows a peak of hexagonal MoS₂.

### DESCRIPTION OF EMBODIMENTS

An oxygen reduction catalyst of the present invention contains as constituent elements cobalt, sulfur, and a transition metal element M being at least one element selected from the group consisting of chromium and molybdenum, is ascertained to have a crystal structure of a cobalt disulfide cubic crystal in powder X-ray diffraction measurement, and has a molar ratio of the transition metal element M to cobalt (M/cobalt) of 5/95 to 15/85.

The oxygen reduction catalyst of the present invention contains as constituent elements cobalt, sulfur, and a transition metal element M other than cobalt, and the transition metal element M is at least one element selected from the group consisting of chromium and molybdenum. That is, the oxygen reduction catalyst of the present invention contains as constituent elements at least: cobalt, sulfur, and chromium; cobalt, sulfur, and molybdenum; or cobalt, sulfur, chromium, and molybdenum.

The molar ratio of the transition metal element M contained in the oxygen reduction catalyst of the present invention to cobalt (M/cobalt) is 5/95 to 15/85, preferably 7.5/92.5 to 15/85, and more preferably 10/90 to 15/85. When the molar ratio (M/cobalt) is smaller than 5/95, Co and S are liable to detach, so that the durability as a catalyst is not sufficient. In addition, when the molar ratio (M/cobalt) is larger than 15/85, a sulfide of the inert transition metal element M alone is preferentially produced, so that the catalyst performance is deteriorated.

When the oxygen reduction catalyst of the present invention contains both of chromium and molybdenum each as the transition metal element M, the molar ratio refers to the total molar ratio of chromium and molybdenum. When unreacted sulfur that does not constitute a sulfide of cobalt is left, there is a possibility that the unreacted sulfur deteriorates the durability of the oxygen reduction catalyst. Accordingly, it is preferable that the unreacted sulfur be removed sufficiently in the production method, which will be described later; however, the unreacted sulfur may be contained to such an extent that does not deteriorate the durability of the oxygen reduction catalyst.

The amount of sulfur contained in the oxygen reduction catalyst of the present invention to the total of cobalt and the transition metal element M is 1:1.90 to 1:2.10 and preferably 1:1.95 to 1:2.05 (total of cobalt and M:sulfur). The molar ratio of the constituent elements above can be checked by a usual element analysis method. The amount of sulfur contained in the catalyst can be obtained, for example, using a carbon/sulfur analyzer EMIA-920V (manufactured by HORIBA, Ltd.). The amount of metals, such as cobalt, contained in the catalyst can be obtained by completely decomposing a sample by heating using sulfuric acid, nitric acid, hydrofluoric acid, and the like appropriately to prepare a solution adjusted to a constant volume and performing measurement using an element analyzer VISTA-PRO (manufactured by SII).

The oxygen reduction catalyst of the present invention is ascertained to have a crystal structure of a cobalt disulfide cubic crystal in powder X-ray diffraction measurement. The oxygen reduction catalyst of the present invention may contain other crystal structures in a range where catalyst properties are not lowered; however, the crystal structure of the cobalt disulfide cubic crystal is mainly ascertained in the powder X-ray diffraction measurement.

The oxygen reduction catalyst of the present invention has a cobalt disulfide cubic crystal content of preferably 80% or more. The cobalt disulfide cubic crystal content is more preferably 90% and more preferably 100%. In the present specification, the cobalt disulfide cubic crystal content (hereinafter, also referred to as “cubic CoS₂ content”) refers to a percentage of the content of the cobalt disulfide cubic crystal based on the total amount of the metal sulfide crystal, the percentage being ascertained in the X-ray diffraction (XRD) measurement. This cubic CoS₂ content is a value determined as described below from the diffraction peak intensities in the XRD spectrum.

For every crystal of all the metal sulfides ascertained in the XRD spectrum of the oxygen reduction catalyst, including the crystal of the cobalt disulfide cubic crystal, the peak intensity of the strongest diffraction intensity among the peaks belonging to each metal sulfide is determined. The intensity ratio (%) obtained by calculating a ratio of the peak intensity of the crystal of the cobalt disulfide cubic crystal as a numerator to the sum of the peak intensities of the metal sulfide crystals including the crystal of the cobalt disulfide cubic crystal as a denominator and multiplying the ratio by 100 is defined as the cubic CoS₂ content.

As one example, when the crystal of a cobalt disulfide cubic crystal, the crystal of a chromium sulfide monoclinic crystal, and the crystal of molybdenum sulfide hexagonal crystal are ascertained in the XRD spectrum, the height (Ha) of a peak having the strongest diffraction intensity among the peaks belonging to the crystal of the cobalt disulfide cubic crystal, the height (Hb) of a peak having the strongest diffraction intensity among the peaks belonging to the crystal of the chromium sulfide monoclinic crystal, and the height (Hc) of a peak having the strongest diffraction peak among the peaks belonging to the crystal of the molybdenum sulfide hexagonal crystal are each determined by subtracting the height of each base line from the peak height of each peak, and the cobalt disulfide cubic crystal content (cubic CoS₂ content) in the oxygen reduction catalyst is determined according to the following equation.

Cubic CoS₂ content (%)=[Ha/(Ha+Hb+Hc)]×100

A general equation is expressed as follows when the sum of all the peak intensities of the crystals of the metal sulfides including the crystal of the cobalt disulfide cubic crystal is represented by ΣHS.

Cubic CoS₂ content (%)=[Ha/ΣHs]×100

It is not preferable that the cubic CoS₂ content is smaller than 80% due to the existence of the crystal structure of the CrS₂ monoclinic crystal and the crystal structure of the MoS₂ hexagonal crystal or the like in the oxygen reduction catalyst because either or both of the oxygen reduction properties of the oxygen reduction catalyst are low as shown by Comparative Examples, which will be described later.

As an X-ray diffraction measurement apparatus, for example, Panalytical MPD, manufactured by Spectris Co., Ltd., or the like can be used. Examples of the measurement conditions include X-ray output (Cu-Kα): 45 kV, 180 mA, scan axis: θ/2θ, measurement range (2θ): 10° to 90°, measurement mode: FT, reading width: 0.02°, sampling time: 0.70 seconds, DS, SS, RS: 0.5°, 0.5°, 0.15 mm, and goniometer radius: 185 nm.

When diffraction peaks corresponding to 2θ=32.4°, 36.3°, 39.9°, 46.4°, and 55.1° listed in crystal information of reference code 01-070-2865 are observed in powder X-ray diffraction measurement, it is ascertained that the catalyst has a crystal structure of the cobalt disulfide cubic crystal. These peaks each shift to a higher angle correlating with the amount of chromium contained as a constituent element in the catalyst, each shift to a lower angle correlating with the amount of molybdenum, and when both chromium and molybdenum are contained, each shift to a higher angle or a lower angle by an amount according to the result of cancelling the amount of shift each other.

The oxygen reduction catalyst of the present invention contains as constituent elements chromium and/or molybdenum in addition to cobalt and sulfur and can thereby exhibit higher catalytic activity than a catalyst containing a transition metal element, such as, for example, tungsten, other than chromium and molybdenum.

### <Method for Producing Oxygen Reduction Catalyst>

The oxygen reduction catalyst of the present invention can be produced by synthesis of a metal sulfide and an annealing treatment of the metal sulfide.

### (Synthesis of Metal Sulfide)

The metal sulfide is synthesized by reacting a cobalt compound and a compound of the transition metal element M with a sulfur source.

There are no particular limitations on the cobalt compound as long as it is decomposed during the reaction to produce cobalt; however, a carbonyl compound of cobalt is preferably used considering simplicity. Specifically, octacarbonyldicobalt and the like can be suitably used. There are no particular limitations on the compound of the transition metal element M as long as it produces chromium or molybdenum; however, a carbonyl compound of the transition metal element M is preferably used considering simplicity. Specifically, hexacarbonylchromium, hexacarbonylmolybdenum, and the like are used suitably.

The amount of the cobalt compound to be used and of the transition metal element M to be used are amounts such that the molar ratio of cobalt to the transition metal element M (M/cobalt) is 5/95 to 15/85. With respect to the molar ratio of sulfur to the total of cobalt and the transition element M, the molar ratio in the amounts charged is almost the same as the molar ratio in a resultant oxygen reduction catalyst.

The sulfur source is preferably a sulfur powder. The molar ratio of sulfur to the total amount of the transition metal element M contained in the transition metal compound (sulfur/M) at the time of loading is preferably in a range of 2 to 10, and more preferably in a range of 4 to 10. When the molar ratio is smaller than 2, a sulfide of cobalt, the sulfide having a composition of a low sulfur ratio such as Co₉S₈ or CoS and having low oxygen reduction ability, is produced instead of cobalt disulfide, and therefore the performance of a resultant catalyst is deteriorated. In addition, when the molar ratio is larger than 10, unreacted sulfur cannot be removed completely and is left, and there is a possibility of deteriorating the durability of a resultant catalyst.

The reaction of the cobalt compound and the compound of the transition metal element M with the sulfur source may be performed, for example, using a solvent such as p-xylene and heating the solvent at a temperature lower than the boiling point of the solvent for 8 to 30 hours in an atmosphere of an inert gas such as a nitrogen gas while the solvent is refluxed. It is preferable that a resultant powder of the metal sulfide be removed sufficiently using a solvent, such as p-xylene, heated to a temperature lower than the boiling point so that unreacted sulfur will not be left.

### (Annealing Treatment of Metal Sulfide)

The metal sulfide produced in the above-described process is subjected to an annealing treatment.

The atmosphere during the annealing treatment may be an inert atmosphere and is preferably a nitrogen gas or argon gas atmosphere.

The temperature in the annealing treatment is usually 300 to 500° C. and preferably 350 to 450° C. When the annealing treatment temperature is higher than 500° C., sulfur is liable to be eliminated and cobalt disulfide (CoS₂) converts to polymorphous cobalt sulfide (CoS), including a hexagonal crystal, which is inferior in oxygen reduction ability. In addition, sintering and particle growth between particles of a resultant oxygen reduction catalyst occur to make the specific surface area of the catalyst small, so that the catalyst is inferior in catalyst performance in some cases. On the other hand, when the annealing treatment temperature is lower than 300° C., sufficient crystallinity is not obtained to make it difficult to obtain an oxygen reduction catalyst having high durability.

The time for the annealing treatment is usually 1 to 8 hours and preferably 2 to 6 hours. When unreacted sulfur is contained in the metal sulfide, the unreacted sulfur is sublimated in the annealing treatment and adheres to the inside of a quartz glass tube of an annealing apparatus in some cases. Unreacted sulfur that cannot be removed completely in the above-described synthesis process can be removed in the annealing treatment.

### <Catalyst Layer>

A catalyst layer, for example, a catalyst layer for a fuel cell, can be produced from the oxygen reduction catalyst.

A catalyst component of the catalyst layer preferably consists of the oxygen reduction catalyst of the present invention. The catalyst component may contain a promoter other than the oxygen reduction catalyst of the present invention, but the promoter is not necessary.

The catalyst layer for a fuel cell contains the oxygen reduction catalyst and a polymer electrolyte. Further, an electron-conductive particle may be contained in the catalyst layer in order to reduce electric resistance more in the catalyst layer.

Examples of the material of the electron-conductive particle include carbon, electrically conductive polymers, electrically conductive ceramics, metals, or conductive inorganic oxides such as tungsten oxide or iridium oxide, and these may be used singly or in combination. Particularly, with respect to the electron-conductive particle made of carbon, the specific surface area is large, those having a small particle diameter are available easily and inexpensively, and the chemical resistance is excellent, and therefore carbon alone or a mixture of carbon and another electron-conductive particle is preferable.

Examples of carbon include carbon black, graphite, activated carbon, a carbon nanotube, a carbon nanofiber, a carbon nanohorn, porous body carbon, and graphene. With respect to the particle diameter of the electron-conductive particle made of carbon, there is a tendency that when the particle diameter is too small, an electron-conductive path is hard to form, and when the particle diameter is too large, deterioration of gas diffusion properties in the catalyst layer for a fuel cell and lowering of the utilization rate of the catalyst occur, and therefore the particle diameter is preferably 10 to 1000 nm and more preferably 10 to 100 nm.

When the electron-conductive particle is made of carbon, the mass ratio of the oxygen reduction catalyst to the electron-conductive particle (catalyst:electron-conductive particle) is preferably 1:1 to 100:1.

The catalyst layer for a fuel cell usually contains a polymer electrolyte. The polymer electrolyte is not particularly restricted as long as it is generally used in a catalyst layer for a fuel cell. Specific examples thereof include perfluorocarbon polymers (for example, NAFION (R)) having a sulfonate group, hydrocarbon-based polymer compounds having a sulfonate group, polymer compounds containing an inorganic acid such as phosphoric acid doped therein, organic/inorganic hybrid polymers part of which is substituted by a proton-conductive functional group, and proton-conductive bodies obtained by impregnating a polymer matrix with a phosphoric acid solution or a sulfonic acid solution. Among these, NAFION (R) is preferable. Examples of a supply source of NAFION (R) in forming the catalyst layer for a fuel cell include 5% NAFION (R) solution (DE521, manufactured by E. I. duPont de Nermours and Company).

There are no particular limitations on a method for forming the catalyst layer for a fuel cell, and examples thereof include a method in which a suspension obtained by dispersing the above-described constituent materials of the catalyst layer for a fuel cell in a solvent is applied on an electrolyte membrane or a gas diffusion layer, which will be described later. Examples of the application method include a dipping method, a screen printing method, a roll coating method, a spray method, and a bar coater application method. Examples of the method for forming the catalyst layer for a fuel cell also include a method in which the above-described suspension obtained by dispersing the constituent materials of the catalyst layer for a fuel cell is applied on a base material by an application method, thereby forming the catalyst layer for a fuel cell, and the catalyst layer for a fuel cell is thereafter formed on an electrolyte membrane by a transfer method.

### <Electrode>

An electrode of the present invention has the catalyst layer for a fuel cell and usually include a gas diffusion layer. Hereinafter, an electrode including an anode catalyst layer is referred to as an anode, and an electrode including a cathode catalyst layer is referred to as a cathode.

The gas diffusion layer is a layer which is porous and assists diffusion of a gas. The gas diffusion layer may be any of layers having electron conductivity, having high gas diffusion properties, and having high corrosion resistance; however, generally, carbon-based porous materials such as carbon paper and carbon cloth are used.

### <Membrane Electrode Assembly>

A membrane electrode assembly of the present invention is constituted by a cathode, an anode, and a polymer electrolyte membrane disposed between the cathode and the anode, the cathode and/or the anode are the electrodes. The catalyst of the present invention has high oxygen reduction ability and therefore is preferably used as the cathode. In addition, the membrane electrode assembly may have a gas diffusion layer.

As the polymer electrolyte membrane, for example, a polymer electrolyte membrane using a perfluorosulfonic acid-based polymer, or a polymer electrolyte membrane or the like using a hydrocarbon-based polymer is generally used; however, a membrane obtained by impregnating a polymer microporous membrane with a liquid electrolyte, or a membrane or the like obtained by filling a porous body with a polymer electrolyte may be used.

The membrane electrode assembly can be obtained by forming the catalyst layer for a fuel cell on the electrolyte membrane and/or the gas diffusion layer and thereafter interposing both faces of the electrolyte membrane by the gas diffusion layer with the cathode catalyst layer and the anode catalyst layer facing the inside and performing, for example, hot press.

### <Fuel Cell>

A fuel cell of the present invention includes the membrane electrode assembly. Examples of the fuel cell include a molten-carbonate fuel cell (MCFC), a phosphoric acid fuel cell (PAFC), a solid oxide fuel cell (SOFC), and a polymer electrolyte (PEFC). Among them, the membrane electrode assembly is preferably used for a polymer electrolyte fuel cell, and hydrogen, methanol, or the like can be used as fuel.

The oxygen reduction catalyst has high durability in a PEFC operating environment, and therefore the PEFC of the present invention, having the oxygen reduction catalyst, has high durability in an operating environment.

### EXAMPLES

Hereinafter, the present invention will be described more specifically by Examples, but the present invention is not restricted by these Examples.

### Example 1

### (1) Catalyst Preparation Process

Into a four-necked flask, 0.654 g of a sulfur powder (manufactured by FUJIFILM Wako Pure Chemical Corporation) and 150 mL of p-xylene (manufactured by FUJIFILM Wako Pure Chemical Corporation) were weighed and loaded, and reflux was performed in a nitrogen gas atmosphere for 30 minutes while the temperature was kept at 110° C. After a resultant mixture was cooled to room temperature, 0.679 g of octacarbonyldicobalt (manufactured by FUJIFILM Wako Pure Chemical Corporation) and 0.04 g of hexacarbonylchromium (manufactured by FUJIFILM Wako Pure Chemical Corporation) were weighed and added to the four-necked flask. Reflux was performed again in a nitrogen gas atmosphere for 24 hours while the temperature was kept at 110° C. After a resultant mixture was cooled to room temperature, filtration and washing were performed using ethanol (manufactured by FUJIFILM Wako Pure Chemical Corporation), and a residue was dried in a vacuum dryer for 6 hours to obtain a powder.

Subsequently, the powder was placed in a stream of a nitrogen gas (gas flow rate of 100 mL/min) using a quartz tube furnace, the temperature was increased from room temperature to 400° C. at a temperature increasing rate of 10° C./min, and an annealing treatment was performed by firing the powder at 400° C. for 2 hours to obtain an oxygen reduction catalyst (1).

The molar ratio (mol %) of cobalt to chromium, based on 100 mol % of the total amount of cobalt and chromium contained in the oxygen reduction catalyst (1), is shown in Table 1. These molar ratios were determined by calculation from the amount of raw materials charged.

### (2) Electrochemical Measurement

### (Preparation of Catalyst Electrode)

Measurement of the oxygen reduction activity of the oxygen reduction catalyst was performed as follows. A solution containing 15 mg of the obtained oxygen reduction catalyst (1), 1.0 mL of 2-propanol, 1.0 mL of ion-exchanged water, and 62 μL of NAFION (R) (5% NAFION (R) aqueous solution, manufactured by FUJIFILM Wako Pure Chemical Corporation) was stirred and suspended by ultrasonic waves to be mixed. On a glassy carbon electrode (manufactured by TOKAI CARBON CO., LTD., diameter: 5.2 mm), 20 μL of this mixture was applied, and the applied mixture was dried at 70° C. for 1 hour to obtain a catalyst electrode for measuring the catalytic activity.

### (Measurement of Catalytic Activity)

The electrochemical measurement of the oxygen reduction catalyst ability of the oxygen reduction catalyst (1) was performed as follows. The prepared catalyst electrode was polarized in a 0.5 mol/dm³ sulfuric acid aqueous solution at 30° C. at a potential scanning rate of 5 mV/sec in an oxygen gas atmosphere and in a nitrogen gas atmosphere to measure a current-potential curve. On that occasion, a reversible hydrogen electrode in a sulfuric acid aqueous solution having the same concentration was used as a reference electrode.

Based on the results of the electrochemical measurement, the electrode potential at 10 μA was obtained from the current-potential curve obtained by subtracting a reduction current in the nitrogen gas atmosphere from a reduction current in the oxygen atmosphere, and the oxygen reduction catalyst ability of the oxygen reduction catalyst (1) was evaluated by this electrode potential. This electrode potential is shown in Table 1.

### (Acid Immersion Test)

The electrode after the measurement of the catalytic activity was immersed in a 0.5 mol/dm³ sulfuric acid aqueous solution at 80° C. for 8 hours. Thereafter, the electrode potential at 10 μA was obtained by the same operation as in the measurement of the catalytic activity. A ratio (%) of the electrode potential at 10 μA after the acid immersion test of the catalyst electrode to the electrode potential at 10 μA before the acid immersion test is defined as a retention rate, and this retention rate was used as an index of durability. The retention rate of the electrode potential is shown in Table 1.

### (3) Powder X-Ray Diffraction Measurement

Powder X-ray diffraction measurement was performed for the sample using Panalytical MPD manufactured by Spectris Co., Ltd. The measurement was performed using a 45 kW Cu-Kα line as an X-ray diffraction measurement condition in a measurement range of a diffraction angle of 20=10 to 90° to determine the crystal structure of the oxygen reduction catalyst (1). From the peaks of the XRD spectrum, the crystal structure of the oxygen reduction catalyst (1) was identified as cubic CoS₂. A peak indicating the existence of another crystal was not observed.

Base line correction was performed to subtract the height of the base line from the height of each peak for the obtained XRD spectrum using analysis software “High Score Plus” included in the apparatus. The base line correction was performed by automatic setting under conditions including the granularity: 30 and the bending factor: 4. The cubic CoS₂ content was determined as described above to find that the oxygen reduction catalyst (1) had a cubic CoS₂ content of 100%. The obtained XRD spectrum is shown in FIG. 1.

### (4) Acid Dissolution Test for Catalyst

Into 100 mL of a 0.5 mol/dm³ sulfuric acid aqueous solution, 0.01 g of the oxygen reduction catalyst (1) was added, and a resultant mixture was stirred at 80° C. for 8 hours. After stirring was completed, an obtained solution was fractionated, and a cobalt dissolution rate was calculated by an ICP-AES method using Vita-Pro manufactured by Hitachi High-Tec Science Corporation. The cobalt dissolution rate was determined as a ratio (%) of the amount of cobalt contained in the sulfuric acid aqueous solution after the completion of stirring to the amount of cobalt contained in the oxygen reduction catalyst (1) before the oxygen reduction catalyst (1) was added to the sulfuric acid aqueous solution. The result is shown in Table 1.

### Example 2

An oxygen reduction catalyst (2) was prepared in the same manner as in Example 1 except that the amount of octacarbonyldicobalt was changed to 0.644 g, and the amount of hexacarbonylchromium was changed to 0.08 g.

The molar ratio (mol %) of cobalt to chromium, based on 100 mol % of the total amount of cobalt and chromium contained in the oxygen reduction catalyst (2), is shown in Table 1. The powder X-ray diffraction measurement was performed for the oxygen reduction catalyst (2) in the same manner as in Example 1. An XRD spectrum showing peaks which are similar to those in FIG. 1 was obtained. The crystal structure of the oxygen reduction catalyst (2) was identified as cubic CoS₂. A diffraction peak indicating the existence of another crystal was not observed to find that the oxygen reduction catalyst (2) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Example 3

The oxygen reduction catalyst (3) was prepared in the same manner as in Example 1 except that the amount of octacarbonyldicobalt was changed to 0.608 g, and the amount of hexacarbonylchromium was changed to 0.12 g.

The molar ratio (mol %) of cobalt to chromium, based on 100 mol % of the total amount of cobalt and chromium contained in the oxygen reduction catalyst (3), is shown in Table 1.

The powder X-ray diffraction measurement was performed for the oxygen reduction catalyst (3) in the same manner as in Example 1. An XRD spectrum showing peaks which are similar to those in FIG. 1 was obtained. The crystal structure of the oxygen reduction catalyst (3) was identified as cubic CoS₂. A diffraction peak indicating the existence of another crystal was not observed to find that the oxygen reduction catalyst (3) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Example 4

An oxygen reduction catalyst (4) was prepared in the same manner as in Example 1 except that 0.04 g of hexacarbonylchromium was changed to 0.049 g of hexacarbonylmolybdenum (manufactured by FUJIFILM Wako Pure Chemical Corporation).

The molar ratio (mol %) of cobalt to molybdenum, based on 100 mol % of the total amount of cobalt and molybdenum contained in the oxygen reduction catalyst (4), is shown in Table 1.

The powder X-ray diffraction measurement was performed for the oxygen reduction catalyst (4) in the same manner as in Example 1. An XRD spectrum showing peaks which are similar to those in FIG. 1 was obtained. The crystal structure of the oxygen reduction catalyst (4) was identified as cubic CoS₂. A diffraction peak indicating the existence of another crystal was not observed to find that the oxygen reduction catalyst (4) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Example 5

An oxygen reduction catalyst (5) was prepared in the same manner as in Example 2 except that 0.08 g of hexacarbonylchromium was changed to 0.098 g of hexacarbonylmolybdenum.

The molar ratio (mol %) of cobalt to molybdenum, based on 100 mol % of the total amount of cobalt and molybdenum contained in the oxygen reduction catalyst (5), is shown in Table 1.

The powder X-ray diffraction measurement was performed for the oxygen reduction catalyst (5) in the same manner as in Example 1. An XRD spectrum showing peaks which are similar to those in FIG. 1 was obtained. The crystal structure of the oxygen reduction catalyst (5) was identified as cubic CoS₂. A diffraction peak indicating the existence of another crystal was not observed to find that the oxygen reduction catalyst (5) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Example 6

An oxygen reduction catalyst (6) was prepared in the same manner as in Example 3 except that 0.12 g of hexacarbonylchromium was changed to 0.147 g of hexacarbonylmolybdenum.

The molar ratio (mol %) of cobalt to molybdenum, based on 100 mol % of the total amount of cobalt and molybdenum contained in the oxygen reduction catalyst (6), is shown in Table 1.

The powder X-ray diffraction measurement was performed for the oxygen reduction catalyst (6) in the same manner as in Example 1. An XRD spectrum showing peaks which are similar to those in FIG. 1 was obtained. The crystal structure of the oxygen reduction catalyst (6) was identified as cubic CoS₂. A diffraction peak indicating the existence of another crystal was not observed to find that the oxygen reduction catalyst (6) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Comparative Example 1

An oxygen reduction catalyst (7) was prepared in the same manner as in Example 1 except that 0.715 of octacarbonyldicobalt alone was added as a metal source.

The powder X-ray diffraction measurement was performed for the oxygen reduction catalyst (7) in the same manner as in Example 1. An XRD spectrum showing peaks which are similar to those in FIG. 1 was obtained. The crystal structure of the oxygen reduction catalyst (7) was identified as cubic CoS₂. A diffraction peak indicating the existence of another crystal was not observed to find that the oxygen reduction catalyst (7) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Comparative Example 2

An oxygen reduction catalyst (8) was prepared in the same manner as in Example 1 except that 0.04 g of hexacarbonylchromium was changed to 0.063 g of hexacarbonyltungsten (manufactured by FUJIFILM Wako Pure Chemical Corporation).

The molar ratio (mol %) of cobalt to tungsten, based on 100 mol % of the total amount of cobalt and tungsten contained in the oxygen reduction catalyst (8), is shown in Table 1. The powder X-ray diffraction measurement was performed for the oxygen reduction catalyst (8) in the same manner as in Example 1. An XRD spectrum showing peaks which are similar to those in FIG. 1 was obtained. The crystal structure of the oxygen reduction catalyst (8) was identified as cubic CoS₂. A diffraction peak indicating the existence of another crystal was not observed to find that the oxygen reduction catalyst (8) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Comparative Example 3

An oxygen reduction catalyst (9) was prepared in the same manner as in Example 2 except that 0.08 g of hexacarbonylchromium was changed to 0.125 g of hexacarbonyltungsten.

The molar ratio (mol %) of cobalt to tungsten, based on 100 mol % of the total amount of cobalt and tungsten contained in the oxygen reduction catalyst (9), is shown in Table 1.

The powder X-ray diffraction measurement was performed for the oxygen reduction catalyst (9) in the same manner as in Example 1. An XRD spectrum showing peaks which are similar to those in FIG. 1 was obtained. The crystal structure of the oxygen reduction catalyst (9) was identified as cubic CoS₂. A diffraction peak indicating the existence of another crystal was not observed to find that the oxygen reduction catalyst (9) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Comparative Example 4

An oxygen reduction catalyst (10) was prepared in the same manner as in Example 3 except that 0.12 g of hexacarbonylchromium was changed to 0.188 g of hexacarbonyltungsten.

The molar ratio (mol %) of cobalt to tungsten, based on 100 mol % of the total amount of cobalt and tungsten contained in the oxygen reduction catalyst (10), is shown in Table 1.

The powder X-ray diffraction measurement was performed for the oxygen reduction catalyst (10) in the same manner as in Example 1. An XRD spectrum showing peaks which are similar to those in FIG. 1 was obtained. The crystal structure of the oxygen reduction catalyst (10) was identified as cubic CoS₂. A diffraction peak indicating the existence of another crystal was not observed to find that the oxygen reduction catalyst (10) had a cubic CoS₂ content of 100%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Comparative Example 5

An oxygen reduction catalyst (11) was prepared in the same manner as in Example 1 except that the amount of octacarbonyldicobalt was changed to 0.572 g, and the amount of hexacarbonylchromium was changed to 0.16 g.

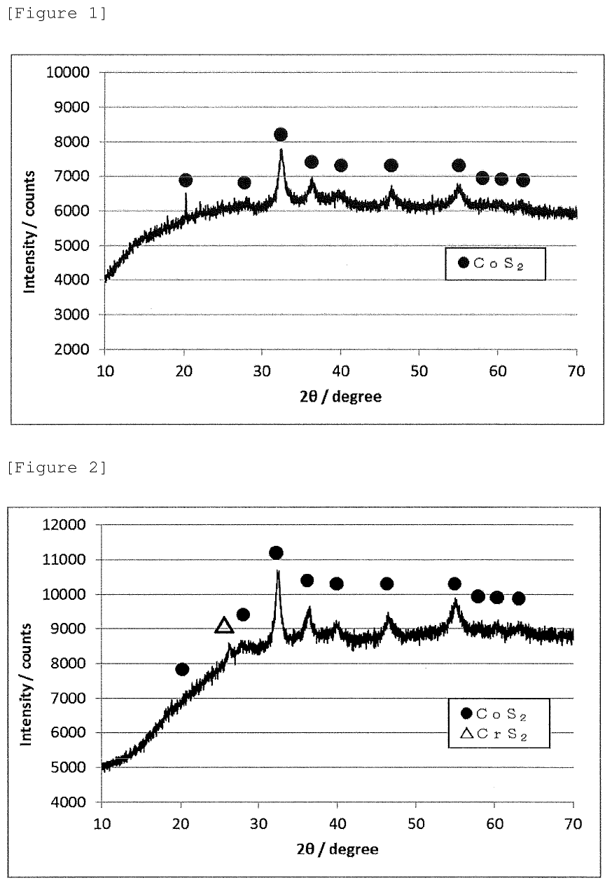

The molar ratio (mol %) of cobalt to chromium, based on 100 mol % of the total amount of cobalt and chromium contained in the oxygen reduction catalyst (11), is shown in Table 1. The powder X-ray diffraction measurement was performed for the oxygen reduction catalyst (11) in the same manner as in Example 1. An XRD spectrum showing a characteristic peak at 26.3° corresponding to monoclinic CrS₂ listed in the reference code 01-072-4210 in addition to peaks which are similar to those in FIG. 1 was obtained. The obtained XRD spectrum is shown in FIG. 2. The oxygen reduction catalyst (11) had a cubic CoS₂ content of 79%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

### Comparative Example 6

An oxygen reduction catalyst (12) was prepared in the same manner as in Example 4 except that the amount of octacarbonyldicobalt was changed to 0.572 g, and the amount of hexacarbonylmolybdenum was changed to 0.196 g.

The molar ratio (mol %) of cobalt to molybdenum, based on 100 mol % of the total amount of cobalt and molybdenum contained in the oxygen reduction catalyst (12), is shown in Table 1.

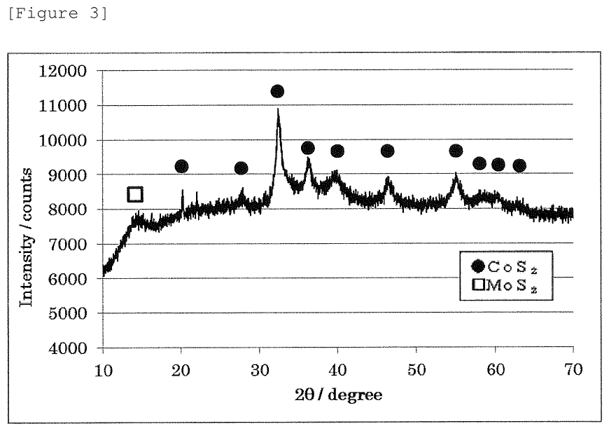

The powder X-ray diffraction measurement was performed for the oxygen reduction catalyst (12) in the same manner as in Example 1. An XRD spectrum showing a characteristic peak at 14.4° corresponding to hexagonal MoS₂ listed in the reference code 98-002-4000, the peak having somewhat low crystallinity, in addition to peaks which are similar to those in FIG. 1 was obtained. The obtained XRD spectrum is shown in FIG. 3. The oxygen reduction catalyst (12) had a cubic CoS₂ content of 77%.

In addition, the electrode potential by the electrochemical measurement, the electrode potential retention rate by the acid immersion test, and the cobalt dissolution rate by the acid dissolution test were measured in the same manner as in Example 1. The results are shown in Table 1.

TABLE 1

| | Molar ratio of transition metal M | | | | | | Electrode | Electrode | | |
|---|---|---|---|---|---|---|---|---|---|---|
| | and of cobalt | | | | | Cubic | potential | potential | Electrode | |
| | Co | Cr | Mo | W | | CoS₂ | (before acid | (after acid | potential | Cobalt |
| | (mol | (mol | (mol | (mol | Crystal | content | immersion) | immersion) | retention | dissolution |
| | %) | %) | %) | %) | structure | (%) | (V) | (V) | rate (%) | rate (%) |
| Example 1 | 95 | 5 | | | CoS₂ cubic | 100 | 0.62 | 0.40 | 64 | 40 |
| | | | | | crystal | | | | | |
| Example 2 | 90 | 10 | | | CoS₂ cubic | 100 | 0.63 | 0.43 | 68 | 36 |
| | | | | | crystal | | | | | |
| Example 3 | 85 | 15 | | | CoS₂ cubic | 100 | 0.62 | 0.42 | 68 | 37 |
| | | | | | crystal | | | | | |
| Example 4 | 95 | | 5 | | CoS₂ cubic | 100 | 0.60 | 0.38 | 64 | 44 |
| | | | | | crystal | | | | | |
| Example 5 | 90 | | 10 | | CoS₂ cubic | 100 | 0.61 | 0.37 | 61 | 43 |
| | | | | | crystal | | | | | |
| Example 6 | 85 | | 15 | | CoS₂ cubic | 100 | 0.59 | 0.38 | 64 | 40 |
| | | | | | crystal | | | | | |
| Comparative | 100 | | | | CoS₂ cubic | 100 | 0.65 | 0.31 | 48 | 54 |
| Example 1 | | | | | crystal | | | | | |
| Comparative | 95 | | | 5 | CoS₂ cubic | 100 | 0.62 | 0.29 | 47 | 52 |
| Example 2 | | | | | crystal | | | | | |
| Comparative | 90 | | | 10 | CoS₂ cubic | 100 | 0.62 | 0.30 | 49 | 58 |
| Example 3 | | | | | crystal | | | | | |
| Comparative | 85 | | | 15 | CoS₂ cubic | 100 | 0.63 | 0.30 | 48 | 50 |
| Example 4 | | | | | crystal | | | | | |
| Comparative | 80 | 20 | | | CoS₂ cubic | 78 | 0.53 | 0.37 | 70 | 36 |
| Example 5 | | | | | crystal, | | | | | |
| | | | | | CrS₂ | | | | | |
| | | | | | monoclinic | | | | | |
| | | | | | crystal | | | | | |
| Comparative | 80 | | 20 | | CoS₂ cubic | 77 | 0.34 | 0.50 | 68 | 40 |
| Example 6 | | | | | crystal, | | | | | |
| | | | | | MoS₂ | | | | | |
| | | | | | hexagonal | | | | | |

### INDUSTRIAL APPLICABILITY

The oxygen reduction catalyst of the present invention can be used as a substitute for platinum that is a catalyst which have conventionally been used for a PEFC.

1. An oxygen reduction catalyst comprising as constituent elements:
cobalt;
sulfur; and
a transition metal element M being at least one element selected from the group consisting of chromium and molybdenum, the oxygen reduction catalyst being ascertained to have a crystal structure of a cobalt disulfide cubic crystal in powder X-ray diffraction measurement and having a molar ratio of the transition metal element M to cobalt (M/cobalt) of 5/95 to 15/85.

2. The oxygen reduction catalyst according to claim 1, having a cobalt disulfide cubic crystal content of 80% or more.

3. An electrode having a catalyst layer comprising the oxygen reduction catalyst according to claim 1.

4. A membrane electrode assembly comprising a polymer electrolyte membrane disposed between a cathode and an anode, wherein the electrode according to claim 3 is used as the cathode and/or the anode.

5. A fuel cell comprising the membrane electrode assembly according to claim 4.

6. An electrode having a catalyst layer comprising the oxygen reduction catalyst according to claim 2.

7. A membrane electrode assembly comprising a polymer electrolyte membrane disposed between a cathode and an anode, wherein the electrode according to claim 6 is used as the cathode and/or the anode.

8. A fuel cell comprising the membrane electrode assembly according to claim 7.
